(19) United States
(12) Patent Application Publication
(10) Pub. No.: US 2025/0224245 A1
(43) Pub. Date: Jul. 10, 2025

(54) IDENTIFICATION OF AN ELECTRIC VEHICLE CHARGING STATION WITHIN A GEOGRAPHIC REGION

(71) Applicant: Zeco Systems, Inc., Los Angeles, CA (US)

(72) Inventor: Jeffrey KINSEY, San Francisco, CA (US)

(21) Appl. No.: 18/851,541

(22) PCT Filed: Feb. 27, 2023
(86) PCT No.: PCT/US2023/063346

§ 371 Date: Sep. 26, 2024

Related U.S. Application Data
(60) Provisional application No. 63/326,209, filed on Mar. 31, 2022.

(51) Int. Cl. G01C 21/36; G01C 21/34

(52) U.S. Cl. CPC G01C 21/3682; G01C 21/3469; G01C 21/3608

(57) ABSTRACT

A method is performed at a server system. The method includes receiving. from a user. a request to search for one or more commercial establishments. The method includes determining that the user satisfies one or more electric vehicle charging criteria. The method includes, in response to the request to search and in accordance with the determination that the user satisfies the one or more electric vehicle charging criteria, providing indications for a subset, less than all, of the one or more commercial establishments, wherein each commercial establishment in the subset is within a predefined proximity of a respective electric vehicle charging station (EVCS).

### TECHNICAL FIELD

This application relates generally to user interfaces for electric vehicle charging station mobile applications, and more particularly, to user interfaces that identify and display navigation instructions to commercial enterprises that are near electric vehicle charging stations.

### BACKGROUND

Electric vehicles are growing in popularity, largely due to their reduced environmental impact and lack of reliance on fossil fuels. As such, the availability of electric vehicle charging stations will play a significant role in users' decisions about where to travel.

Conventional methods and user interfaces within electric vehicle charging station mobile applications include very little information about what is near a respective electric vehicle charging station (EVCS). For example, a user looking to charge their vehicle while grocery shopping typically must search for grocery stores (e.g., in a maps application) and then separately search for nearby charging stations (e.g., in the EVCS mobile application), while remembering where the desired grocery store was located. Not only is this process frustrating for the user, but also leads to an inefficient human-machine interface, as the excess browsing on the user's device reduces its battery power. In addition, this conventional process is error-prone, as a user is very likely to miss the fact that a charging station is co-located with a desirable commercial enterprise. This results in increased mileage and wear and tear on the electric vehicle as the user is forced to go out of their way to charge.

### SUMMARY

The disclosed implementations provide systems (e.g., server systems and client devices) and methods of providing user interfaces in EVCS mobile applications that display information about commercial enterprises that are co-located with electric vehicle charging stations. Displaying information about commercial enterprises co-located with charging stations obviates the need for the user to search for commercial enterprises independently of searching for charging stations (e.g., in a separate maps application). Doing so not only saves time and provides convenience to the user, but also results in a more efficient machine-human interface. That is, reducing the number of inputs needed by the user to determine where to go and where to charge saves battery power for the electronic device and reduces the mileage driven by the electric vehicle (e.g., by directing the user to charging stations that happen to be located near where the user needs to go anyway).

To that end, in accordance with some implementations, a method is performed at a server system with one or more processors and memory. The method includes receiving, from a user, a request to search for one or more commercial establishments. The method includes determining that the user satisfies one or more electric vehicle charging criteria. The method includes, in response to the request to search and in accordance with the determination that the user satisfies the one or more electric vehicle charging criteria, providing indications for a subset, less than all, of the one or more commercial establishments, wherein each commercial establishment in the subset is within a predefined proximity of a respective electric vehicle charging station (EVCS).

Some implementations of the present disclosure provide a computer system (e.g., a server system), comprising one or more processors and memory storing one or more programs. The one or more programs store instructions that, when executed by the one or more processors, cause the computer system to perform any of the methods described herein.

Some implementations of the present disclosure provide a computer program product (e.g., a non-transitory computer readable storage medium storing instructions) that, when executed by a computer system having one or more processors, cause the computer system to perform any of the methods described herein.

### BRIEF DESCRIPTION OF THE DRAWINGS

For a better understanding of the various described implementations, reference should be made to the Detailed Description below, in conjunction with the following drawings in which like reference numerals refer to corresponding parts throughout the figures.

FIG. 1 illustrates a system for charging an electric vehicle in accordance with some implementations.

FIGS. 2A-2C illustrate a charging station for an electric vehicle in accordance with some implementations.

FIG. 3 is a block diagram of a server system in accordance with some implementations.

FIG. 4 is a block diagram of a charging station for an electric vehicle in accordance with some implementations.

FIG. 5 is a block diagram of a user device in accordance with some implementations.

FIGS. 6A-6C illustrate different aspects of a user interface for a mobile application, in accordance with some embodiments.

FIGS. 7A-7B illustrate a flowchart of a method of providing indications of commercial establishments that are within a predefined proximity of an electric vehicle charging station, in accordance with some implementations.

### DETAILED DESCRIPTION

Reference will now be made in detail to implementations, examples of which are illustrated in the accompanying drawings. In the following detailed description, numerous specific details are set forth in order to provide a thorough understanding of the various described implementations. However, it will be apparent to one of ordinary skill in the art that the various described implementations may be practiced without these specific details. In other instances, well-known methods, procedures, components, circuits, and networks have not been described in detail so as not to unnecessarily obscure aspects of the implementations.

Many modifications and variations of this disclosure can be made without departing from its spirit and scope, as will be apparent to those skilled in the art. The specific implementations described herein are offered by way of example only, and the disclosure is to be limited only by the terms of the appended claims, along with the full scope of equivalents to which such claims are entitled.

The disclosed implementations provide systems and methods of providing user interfaces in EVCS mobile applications that display information about commercial enterprises (e.g., having physical locations) that are co-located with electric vehicle charging stations. The remainder of this disclosure provides examples in which the commercial enterprises are retail outlets. One of skill in the art having the benefit of this disclosure, however, will recognize that the systems and methods described herein are equally applicable to other types of commercial enterprises (e.g., entities of commerce, points of commerce, facilities of commerce). For example, in some embodiments, the systems and methods described herein may be used to provide a user with information about ice skating rinks, ski resorts, non-profit centers (e.g., museums), and others. In some embodiments, the systems and methods described herein may be applied to points of interest (POIs) that are not commercial in nature.

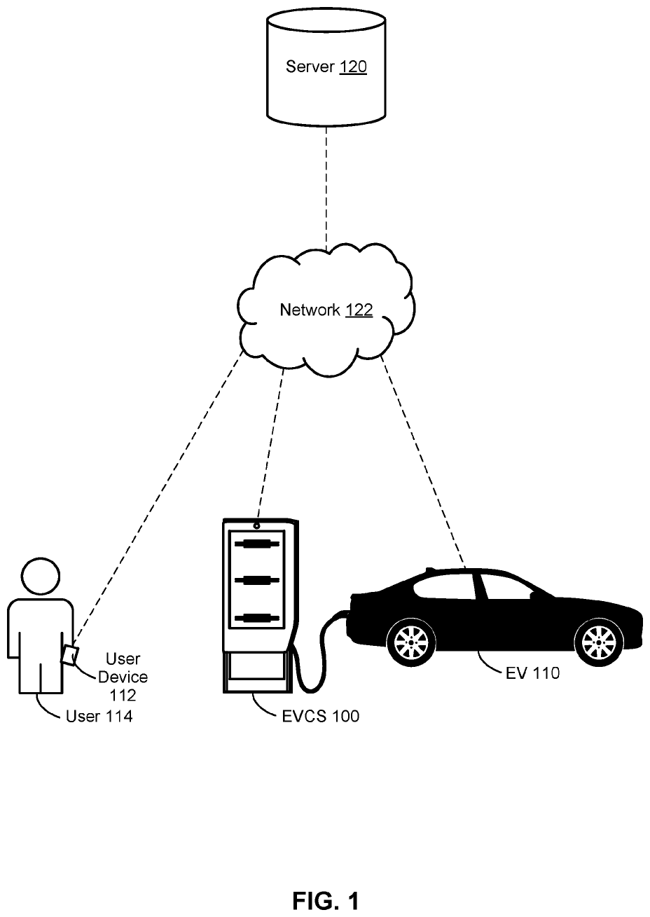

FIG. 1 illustrates an electric vehicle charging station (EVCS) 100 that is configured to provide an electric charge to an electric vehicle 110 via one or more electrical connections. In some implementations, the EVCS 100 provides an electric charge to electric vehicle 110 via a wired connection, such as a charging cable. Alternatively, the EVCS 100 may provide an electric charge to electric vehicle 110 via a wireless connection (e.g., wireless charging). In some implementations, the EVCS 100 may be in communication with the electric vehicle 110 or a user device 112 belonging to a user 114 (e.g., a driver, passenger, owner, renter, or other operator of the electric vehicle 110) that is associated with the electric vehicle 110. In some implementations, the EVCS 100 communicates with one or more devices or computer systems, such as user device 112 or server system 120, respectively, via a network 122.

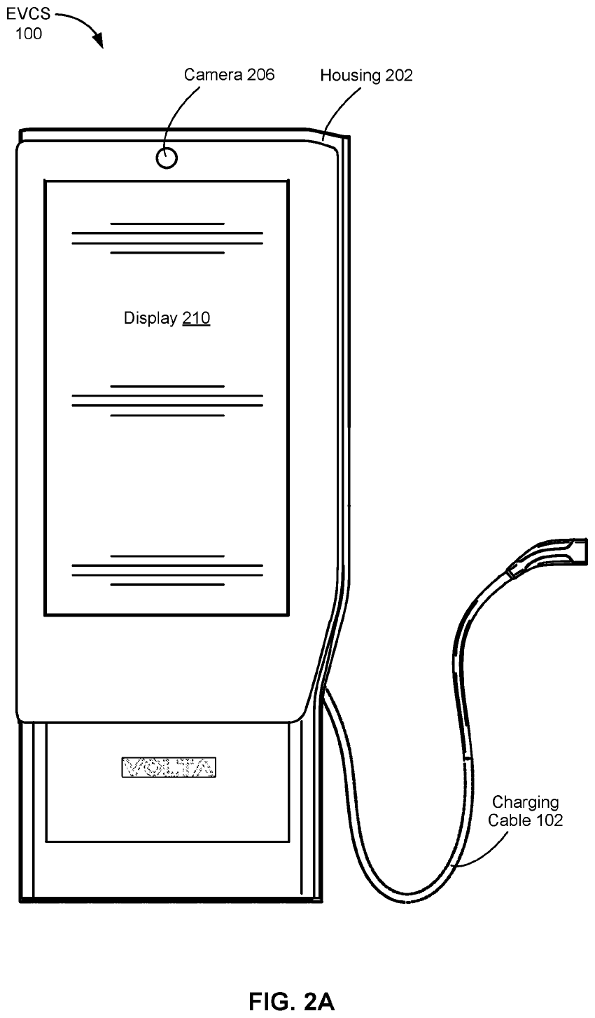

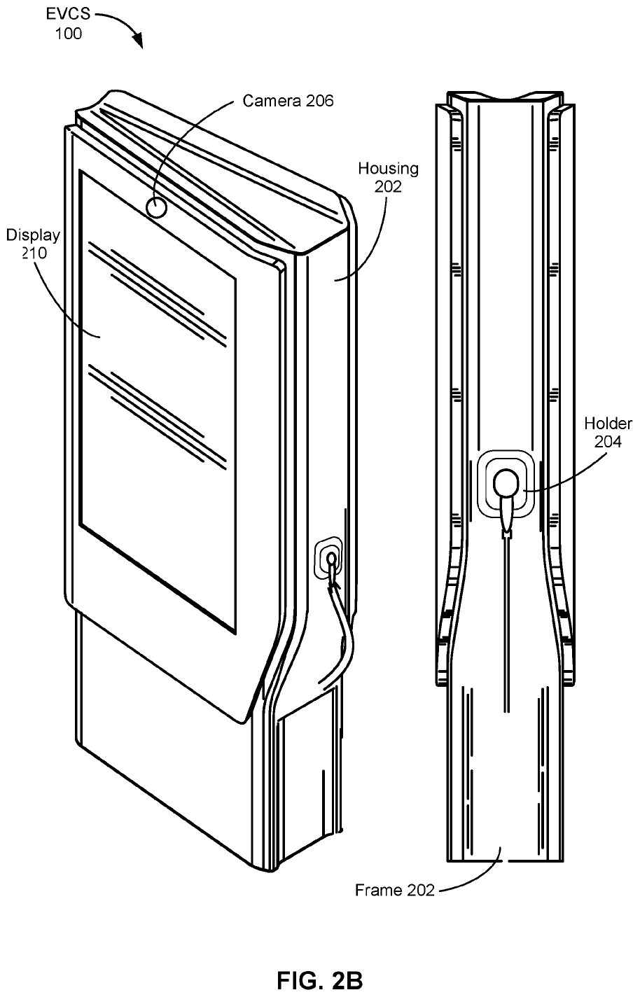

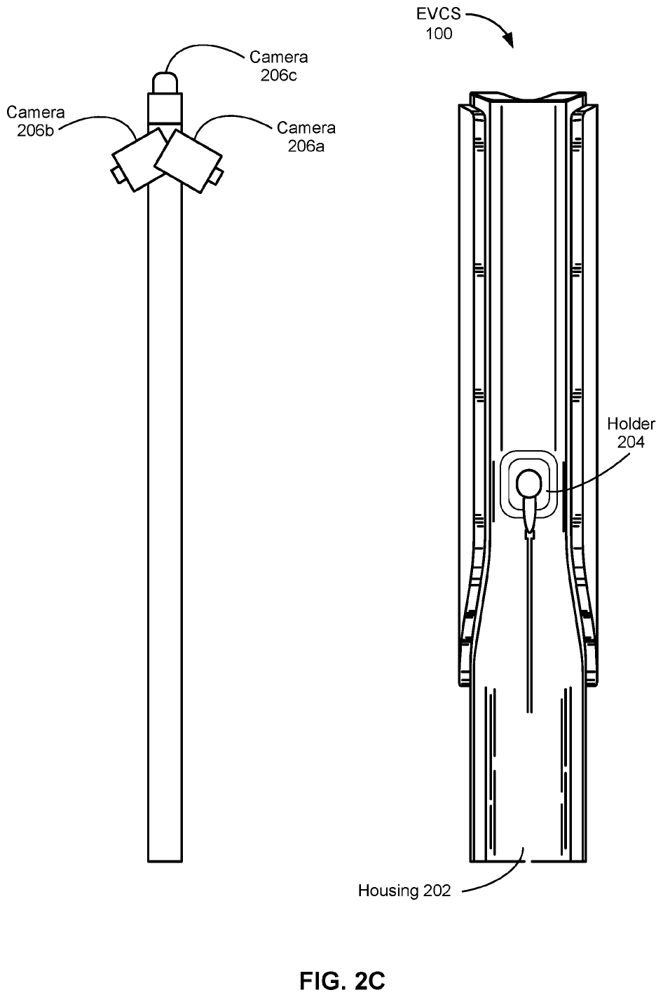

FIG. 2A is a mechanical drawing showing various views of an electric vehicle charging station (EVCS) 100, in accordance with some implementations. FIG. 2B is a mechanical drawing showing additional views of the EVCS 100 of FIG. 2A, in accordance with some implementations. FIG. 2C shows an alternative configuration of EVCS 100, in accordance with some implementations. FIGS. 2A-2C are discussed together below.

EVCS 100 includes a housing 202 (e.g., a body or a chassis) including a charging cable 102 (e.g., connector) configured to connect and provide a charge to an electric vehicle 110 (FIG. 1). An example of a suitable connector is an IEC 62196 type-2 connector. In some implementations, the connector is a “gun-type” connector (e.g., a charge gun) that, when not in use, sits in a holder 204 (e.g., a holster). In some implementations, the housing 202 houses circuitry for charging an electric vehicle 110. For example, in some implementations, the housing 202 includes power supply circuitry as well as circuitry for determining a state of a vehicle being charged (e.g., whether the vehicle is connected via the connector, whether the vehicle is charging, whether the vehicle is done charging, etc.).

The EVCS 100 further includes one or more displays 210 facing outwardly from a surface of the EVCS 100. For example, the EVCS 100 may include two displays 210, one on each side of the EVCS 100, each display 210 facing outwardly from the EVCS 100. In some implementations, the one or more displays 210 display messages (e.g., media content) to users of the charging station (e.g., operators of the electric vehicle) and/or to passersby that are in proximity to the EVCS 100. In some implementations, the panel 106a (and/or panel 106b) has a height that is at least 60% of a height of the housing 202 and a width that is at least 90% of a width of the housing 202. In some implementations, the panel 102 has a height that is at least 3 feet and a width that is at least 2 feet.

In some implementations, the EVCS 100 includes one or more panels that hold a display 210. The displays are large compared to the housing 202 (e.g., 60% or more of the height of the frame and 80% or more of the width of the frame), allowing the displays 210 to function as billboards, capable of conveying information to passersby. In some implementations, the displays 210 are incorporated into articulating panels that articulate away from the housing 202 (e.g., a sub-frame). The articulating panels solve the technical problem of the need for maintenance of the displays 210 (as well as one or more computers that control content displayed on the display). To that end, the articulating panels provide easy access to the entire back of the displays 210. In addition, in some implementations, the remaining space between the articulating panels (e.g., within the housing 202) is hollow, allowing for ample airflow and cooling of the displays 210.

The EVCS 100 further includes a computer that includes one or more processors and memory. The memory stores instructions for displaying content on the display 210. In some implementations, the computer is disposed inside the housing 202. In some implementations, the computer is mounted on a panel that connects (e.g., mounts) a first display (e.g., a display 210) to the housing 202. In some implementations, the computer includes a near-field communication (NFC) system that is configured to interact with a user's device (e.g., user device 112 of a user 114 of the EVCS 100).

In some implementations, the EVCS 100 includes one or more sensors (not shown) for detecting whether external objects are within a predefined region (area) proximal to the housing. For example, the area proximal to the EVCS 100 includes one or more parking spaces, where an electric vehicle 110 parks in order to use the EVCS 100. In some implementations, the area proximal to the EVCS 100 includes walking paths (e.g., sidewalks) next to the EVCS 100. In some implementations, the one or more sensors are configured to determine a state of the area proximal to the EVCS 100 (e.g., wherein determining the state includes detecting external objects). The external objects can be living or nonliving, such as people, kids, animals, vehicles, shopping carts, (kids) toys, etc. The one or more sensors can detect stationary or moving external objects. The one or more sensors of the EVCS 100 include one or more image (e.g., optical) sensors (e.g., one or more cameras 206), ultrasound sensors, depth sensors, IR/RGB cameras, PIR, heat IR, proximity sensors, radar, and/or tension sensors. The one or more sensors may be connected to the EVCS 100 or a computer system associated with the EVCS 100 via wired or wireless connections such as via a Wi-Fi connection or Bluetooth connection.

In some implementations, the housing 202 includes one or more lights configured to provide predetermined illumination patterns indicating a status of the EVCS 100. In some implementations, at least one of the one or more lights is configured to illuminate an area proximal to the EVCS 100 as a person approaches the area (e.g., a driver returning to a vehicle or a passenger exiting a vehicle that is parked in a parking spot associated with the EVCS 100).

In some implementations, the housing 202 includes one or more cameras 206 configured to capture one or more images of an area proximal to the EVCS 100. In some implementations, the one or more cameras 206 are configured to obtain video of an area proximal to the EVCS 100. For example, a camera may be configured to obtain a video or capture images of an area corresponding to a parking spot associated with the EVCS 100. In another example, another camera may be configured to obtain a video or capture images of an area corresponding to a parking spot next to the parking spot of the EVCS 100. In a third example, the camera 206 may be a wide angle camera or a 360° camera that is configured to obtain a video or capture images of a large area proximal to the EVCS 100, including a parking spot of the EVCS 100. As shown in FIG. 2B, the one or more cameras 206 may be mounted directly on a housing 202 of the EVCS 100 and may have a physical (e.g., electrical, wired) connection to the EVCS 100 or a computer system associated with the EVCS 100. Alternatively, as shown in FIG. 2C, the one or more cameras 206 (or other sensors) may be disposed separately from but proximal to the housing 202 of the EVCS 100. In some implementations, the camera 206 may be positioned at different locations on the EVCS 100 than what is shown in the figures. Further, in some implementations, the one or more cameras 206 include a plurality of cameras positioned at different locations on the EVCS 100.

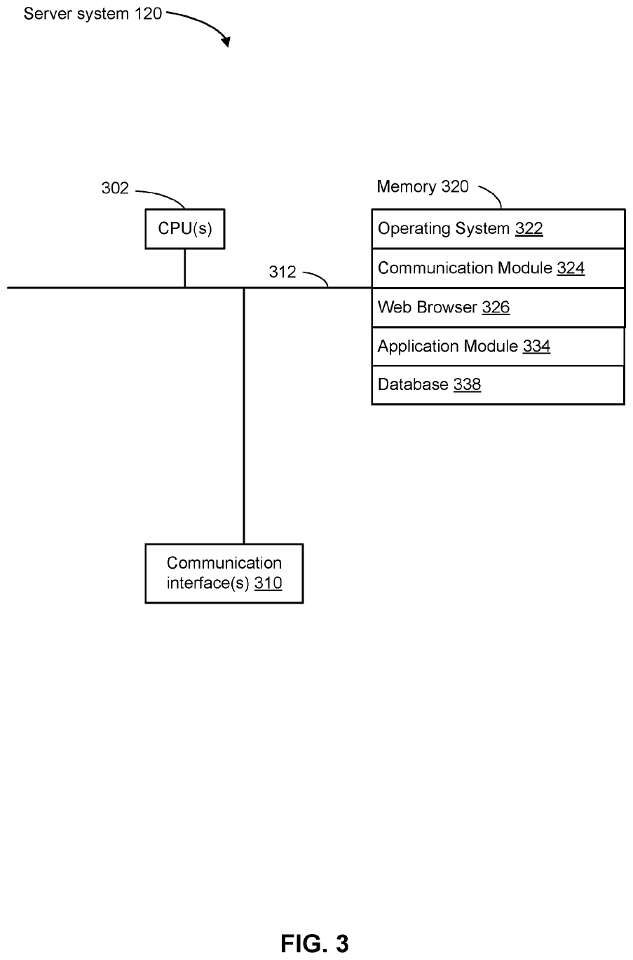

FIG. 3 is a block diagram of a server system 120, in accordance with some implementations. Server system 120 may include one or more computer systems (e.g., computing devices), such as a desktop computer, a laptop computer, and a tablet computer. In some implementations, the server system 120 is a data server that hosts one or more databases (e.g., databases of images or videos), models, or modules or may provide various executable applications or modules. The server system 120 includes one or more processing units (processors or cores, CPU(s)) 302, one or more network or other communications network interfaces 310, memory 320, and one or more communication buses 312 for interconnecting these components. The communication buses 312 optionally include circuitry (sometimes called a chipset) that interconnects and controls communications between system components.

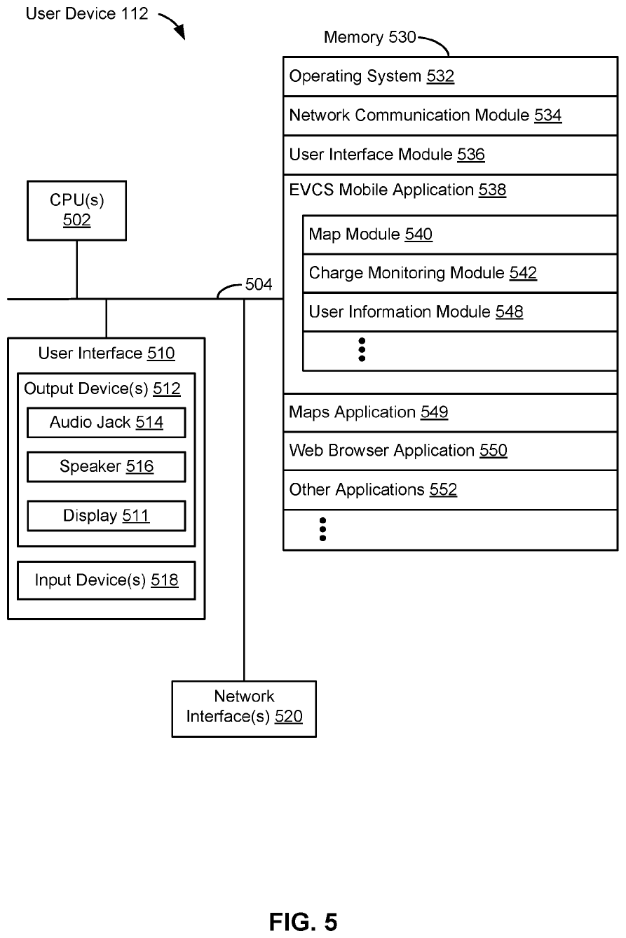

The memory 320 includes high-speed random-access memory, such as DRAM, SRAM, DDR RAM, or other random-access solid-state memory devices; and may include non-volatile memory, such as one or more magnetic disk storage devices, optical disk storage devices, flash memory devices, or other non-volatile solid-state storage devices. In some implementations, the memory 320 includes one or more storage devices remotely located from the processors 302. The memory 320, or alternatively the non-volatile memory devices within the memory 320, includes a non-transitory computer-readable storage medium. In some implementations, the memory 320 or the computer-readable storage medium of the memory 320 stores the following programs, modules, and data structures, or a subset or superset thereof:
an operating system 322, which includes procedures for handling various basic system services and for performing hardware dependent tasks;
a communications module 324, which is used for connecting the server system 120 to other computers and devices via the one or more communication network interfaces 310 (wired or wireless), such as the internet, other wide area networks, local area networks, metropolitan area networks, and so on;
a web browser 326 (or other application capable of displaying web pages), which enables a user to communicate over a network with remote computers or devices;
an application module 334 for providing services to one or more mobile applications (e.g., EVCS mobile application 538 and maps application 549 (FIG. 5)), including responding to requests for available charging stations, identifying (e.g., in database 338) commercial establishments that are co-located with electric vehicle charging stations, responding to search requests for commercial establishments, providing navigation instructions to commercial establishments, transmitting instructions to EVCS mobile application 538 and/or maps application 549 to display indications of available charging stations, together with representations of the co-located commercial establishments, and so forth. In some embodiments, application module 334 includes a plurality of modules, each module corresponding to a distinct mobile application and providing services to the respective mobile application;
database 338 for storing information on electric vehicle charging stations, their availability, commercial establishments that are co-located with said electric vehicle charging stations, and so forth.

Each of the above identified executable modules, applications, or sets of procedures may be stored in one or more of the previously mentioned memory devices and corresponds to a set of instructions for performing a function described above. The above identified modules or programs (i.e., sets of instructions) need not be implemented as separate software programs, procedures, or modules, and thus various subsets of these modules may be combined or otherwise re-arranged in various implementations. In some implementations, the memory 320 stores a subset of the modules and data structures identified above. Furthermore, the memory 320 may store additional modules or data structures not described above.

Although FIG. 3 shows a server system 120, FIG. 3 is intended more as a functional description of the various features that may be present rather than as a structural schematic of the implementations described herein. In practice, and as recognized by those of ordinary skill in the art, items shown separately could be combined and some items could be separated.

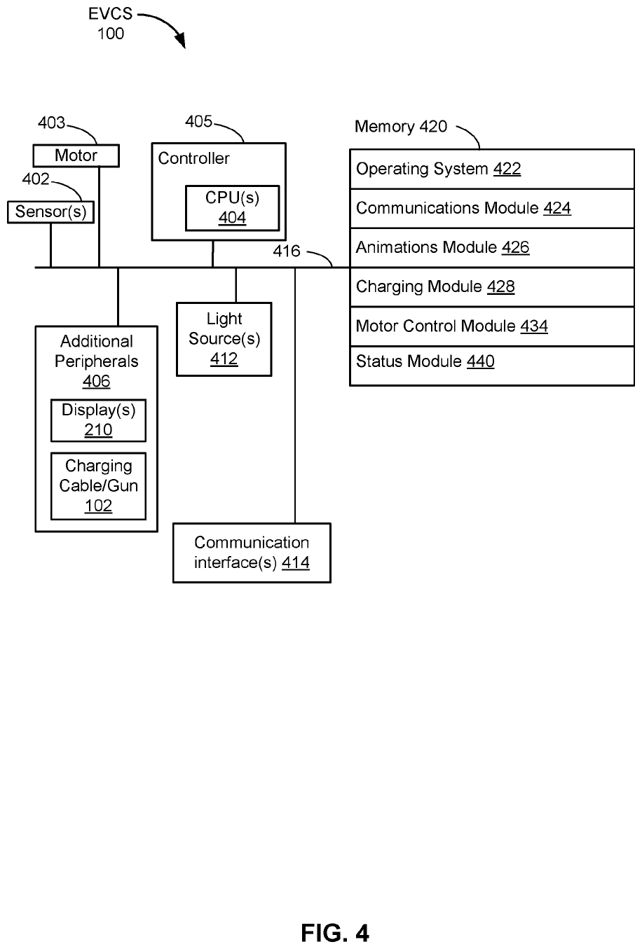

FIG. 4 is a block diagram of an EVCS 100 (FIGS. 1 and 2A-2C) for charging an electric vehicle, in accordance with some implementations. The EVCS 100 optionally includes a motor 403 (configured to retract a portion of a charging cable), a controller 405 that includes one or more processing units (processors or cores) 404, one or more network or other communications network interfaces 414, memory 420, one or more light sources 412, one or more sensors 402, additional peripherals 406, and one or more communication buses 416 for interconnecting these components. The communication buses 416 optionally include circuitry (sometimes called a chipset) that interconnects and controls communications between system components. In some implementations, the memory 420 stores instructions for performing (by the one or more processing units 404) a set of operations, including determining a status of the EVCS 100, wherein the status indicates a state of an electric vehicle 110 at the charging station.

EVCS 100 typically includes additional peripherals 406 such as displays 210 for displaying content, and charging cable 102. In some implementations, the displays 210 may be touch-sensitive displays that are configured to detect various swipe gestures (e.g., continuous gestures in vertical and/or horizontal directions) and/or other gestures (e.g., a single or double tap) or to detect user input via a soft keyboard that is displayed when keyboard entry is needed.

The user interface may also include one or more sensors 402 such as cameras (e.g., camera 206, described above with respect to FIGS. 2A-2B), ultrasound sensors, depth sensors, infrared cameras, visible (e.g., RGB or black and white) cameras, passive infrared sensors, heat detectors, infrared sensors, proximity sensors, or radar. In some implementations, the one or more sensors 402 are for detecting whether external objects are within a predefined region proximal to the housing, such as living and nonliving objects, and/or the status of the EVCS 100 (e.g., available, occupied, etc.) in order to perform an operation, such as retracting the charging cable safely and carefully.

The memory 420 includes high-speed random-access memory, such as DRAM, SRAM, DDR RAM, or other random-access solid-state memory devices; and may include non-volatile memory, such as one or more magnetic disk storage devices, optical disk storage devices, flash memory devices, or other non-volatile solid-state storage devices. In some implementations, the memory 420 includes one or more storage devices remotely located from the processors 404, such as database 338 of server system 120 that is in communication with the EVCS 100. The memory 420, or alternatively the non-volatile memory devices within the memory 420, includes a non-transitory computer-readable storage medium. In some implementations, the memory 420 or the computer-readable storage medium of the memory 420 stores the following programs, modules, and data structures, or a subset or superset thereof:
an operating system 422, which includes procedures for handling various basic system services and for performing hardware dependent tasks;
a communications module 424, which is used for connecting the EVCS 100 to other computers and devices via the one or more communication network interfaces 414 (wired or wireless), such as the internet, other wide area networks, local area networks, metropolitan area networks, and so on;
an animations module 426 for animating the one or more light sources 412 to provide predetermined illumination patterns or to provide illumination for passersby and users of the EVCS 100;
a charging module 428 for charging an electric vehicle (e.g., measuring how much charge has been delivered to an electric vehicle, commencing charging, ceasing charging, etc.);
motor control module 434 that includes one or more instructions for energizing or forgoing energizing the motor; and.
a status module 440 for monitoring a charging status of the EVCS 100 (e.g., a status of the EVCS 100 with respect to charging of an electric vehicle or its ability/inability to charge an electric vehicle).

In some implementations, the memory 420 stores metrics, thresholds, and other criteria, which are compared against the measurements captured by the one or more sensors 402. For example, data obtained from a PIR sensor of the one or more sensors 402 can be compared with baseline data to detect that an object is in proximity the EVCS 100.

Each of the above identified executable modules, applications, or sets of procedures may be stored in one or more of the previously mentioned memory devices and corresponds to a set of instructions for performing a function described above. The above identified modules or programs (i.e., sets of instructions) need not be implemented as separate software programs, procedures, or modules, and thus various subsets of these modules may be combined or otherwise re-arranged in various implementations. In some implementations, the memory 420 stores a subset of the modules and data structures identified above. Furthermore, the memory 420 may store additional modules or data structures not described above.

Although FIG. 4 shows an EVCS 100, FIG. 4 is intended more as a functional description of the various features that may be present rather than as a structural schematic of the implementations described herein. In practice, and as recognized by those of ordinary skill in the art, items shown separately could be combined and some items could be separated.

FIG. 5 is a block diagram of a user device 112 of a user 114 in accordance with some implementations. In some implementations, the user 114 is associated with (e.g., an operator of) an electric vehicle 110 at EVCS 100. Various examples of the user device 112 include a cellular-capable smart device such as a smartphone, a smart watch, a laptop computer, a tablet computer, and other computing devices that have a processor capable of connecting to the EVCS 100 via a communications network (e.g., network 122).

The user device 112 typically includes one or more processing units (processors or cores) 502, one or more network or other communications network interfaces 520, memory 530, and one or more communication buses 504 for interconnecting these components. The communication buses 504 optionally include circuitry (sometimes called a chipset) that interconnects and controls communications between system components. The user device 112 typically includes a user interface 510. The user interface 510 typically includes one or more output devices 512 such as an audio output device 514, such as speakers 516 or an audio output connection (e.g., audio jack) for connecting to speakers, earphones, or headphones. The user interface 510 also typically includes a display 511 (e.g., a screen or monitor). In some implementations, the user device 112 includes input devices 518 such as a keyboard, mouse, and/or other input buttons. Alternatively or in addition, in some implementations, the user device 112 includes a touch-sensitive surface. In some embodiments, the touch-sensitive surface is combined with the display 511, in which case the display 511 is a touch-sensitive display. In some implementations, the touch-sensitive surface is configured to detect various swipe gestures (e.g., continuous gestures in vertical and/or horizontal directions) and/or other gestures (e.g., single/double tap). In computing devices that have a touch-sensitive surface (e.g., a touch-sensitive display), a physical keyboard is optional (e.g., a soft keyboard may be displayed when keyboard entry is needed). Furthermore, user device 112 may also include a microphone and voice recognition software to supplement or replace the keyboard.

The memory 530 includes high-speed random-access memory, such as DRAM, SRAM, DDR RAM, or other random-access solid-state memory devices; and may include non-volatile memory, such as one or more magnetic disk storage devices, optical disk storage devices, flash memory devices, or other non-volatile solid-state storage devices. In some implementations, the memory 530 includes one or more storage devices remotely located from the processors 502. The memory 530, or alternatively the non-volatile memory devices within the memory 530, includes a non-transitory computer-readable storage medium. In some implementations, the memory 530 or the computer-readable storage medium of the memory 530 stores the following programs, modules, and data structures, or a subset or superset thereof:
an operating system 532, which includes procedures for handling various basic system services and for performing hardware dependent tasks;
a network communication module 534, which is used for connecting the user device 112 to other computers and devices via the one or more communication network interfaces 520 (wired or wireless), such as the internet, other wide area networks, local area networks, metropolitan area networks, and so on;
a user interface module 536 for providing user interfaces for the user to interact with the user device 112 via applications on the user device 112 and the operating system 532 of the user device 112;
an EVCS mobile application 538 for communicating with an EVCS 100 or a server system that supports the EVCS 100. In some embodiments, EVCS mobile application 538 is capable of displaying a map of nearby electric vehicle charging stations. As described below, in some embodiments, the map displays indications of nearby electric vehicle charging stations, in which the indications include representations of co-located retail outlets;
a maps application 549 for providing turn-by-turn driving directions to a user. In some embodiments, maps application 549 is enabled to perform some or all of the functionality described with respect to EVCS mobile application 538;
a web browser application 550 for accessing the internet and accessing websites on the internet, including providing functionalities on the EVCS mobile application 538 via a website accessed through web browser application 550; and
other applications 552 that the user 114 may have installed on the user device 112 or that may have been included as default applications on the user device 112.

Each of the above identified executable modules, applications, or sets of procedures may be stored in one or more of the previously mentioned memory devices and corresponds to a set of instructions for performing a function described above. The above identified modules or programs (i.e., sets of instructions) need not be implemented as separate software programs, procedures, or modules, and thus various subsets of these modules may be combined or otherwise re-arranged in various implementations. In some implementations, the memory 530 stores a subset of the modules and data structures identified above. Furthermore, the memory 530 may store additional modules or data structures not described above.

Although FIG. 5 shows a user device 112, FIG. 5 is intended more as a functional description of the various features that may be present rather than as a structural schematic of the implementations described herein. In practice, and as recognized by those of ordinary skill in the art, items shown separately could be combined and some items could be separated.

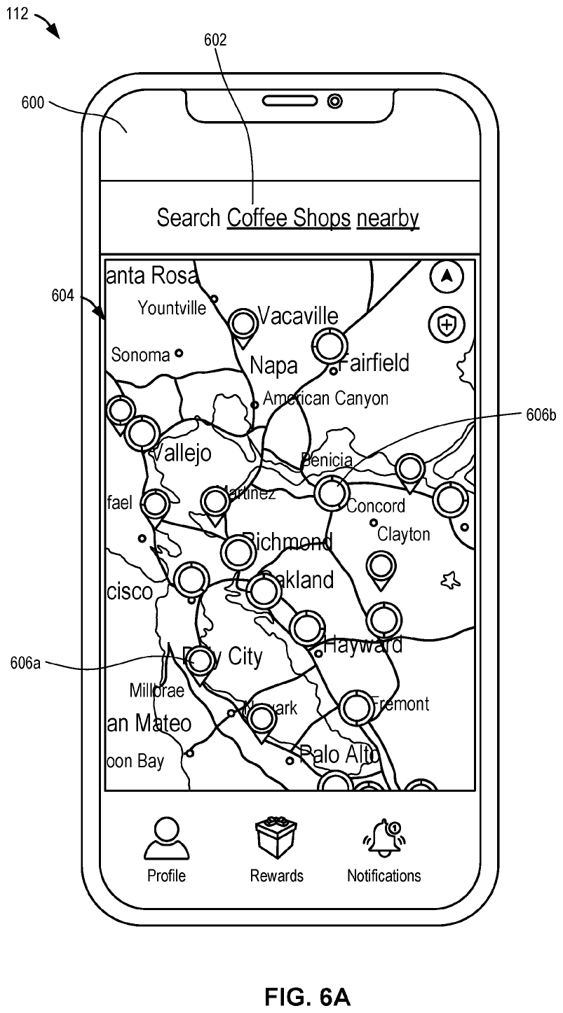

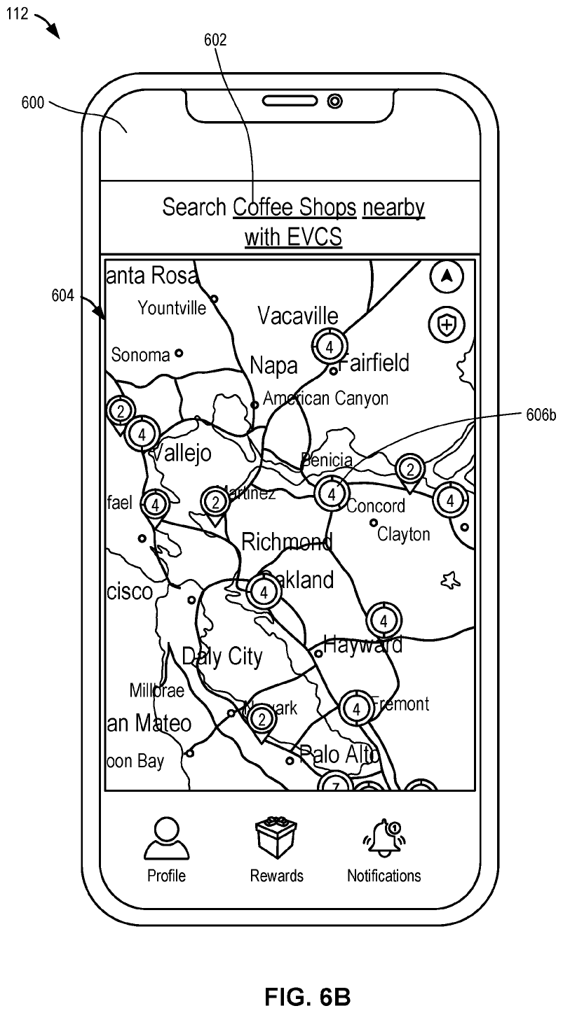

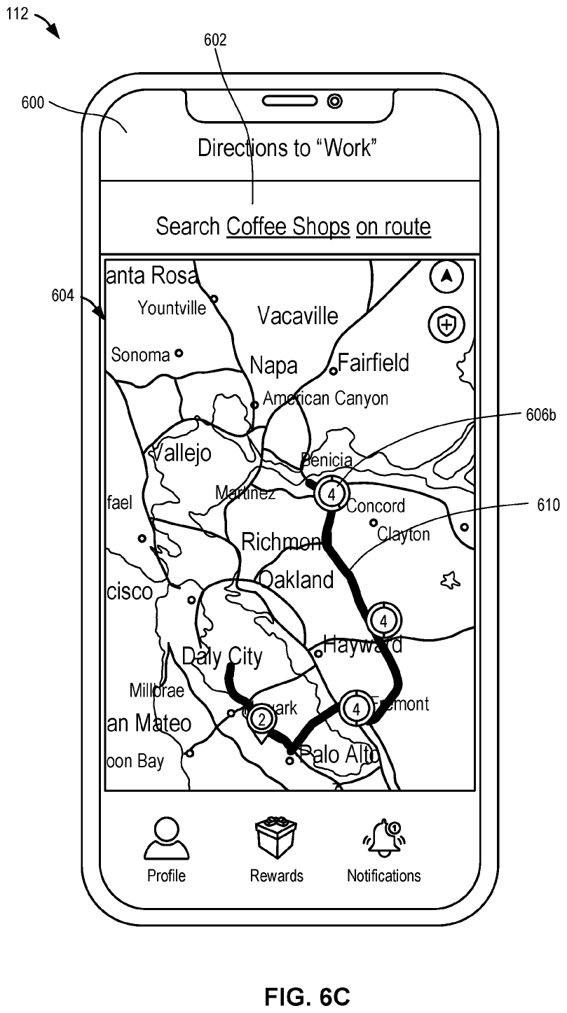

FIG. 6A illustrates a user interface 600 for a mobile application, in accordance with some embodiments. In some embodiments, the mobile application is an EVCS mobile application 538. In some embodiments, the mobile application is a maps application 549, or a web browser application 550. Although FIG. 6A illustrates user interface 600 as displayed on user device 112 (e.g., a portable multifunction device such as a smart phone), in some embodiments, user interface 600 is displayed on a display of a computer system integrated into electric vehicle 110. In some embodiments, the user interface 600 is displayed in response to receiving (e.g., detecting) a request from the user to display location information (e.g., navigation instructions and/or nearby charging stations).

In some embodiments, user interface 600 initially displays a map 604 of a geographical region. In some embodiments, the geographical region is based on a geographic location of user device 112 (e.g., a GPS location of the user device 112). In some embodiments, the map 604 includes an indication of the user's current location.

User interface 600 also allows the user to search for one or more commercial establishments by inputting, via speech or text, a request to search 602. In some embodiments, the request to search 602 indicates a type of commercial establishment (e.g., coffee shop), or a name of a particular commercial establishment (e.g., Starbucks). In some embodiments, the request to search 602 further indicates a geographic region in which to perform the search. For example, FIG. 6A illustrates “nearby” as the geographic region. In some embodiments, a user is enabled to move a current view of the map to select another (e.g., a different) geographic region, and the search is executed for the selected region. In some embodiments, a user is enabled to update the geographic region to the name of a city or other location (e.g., “Search Coffee Shops near San Francisco”). In some embodiments, the geographic region is defined relative to a destination, or relative to a saved location (e.g., “home” or “work”) of the user. In some embodiments, as described with reference to FIG. 6C, the geographic region is defined relative to a navigation route.

In some embodiments, the search results are displayed on map 604 in response to the user entering request to search 602. For example, user interface 600 includes a map 604 of a geographical region. In some embodiments, map 604 displays indications 606 (e.g., indication 606a and indication 606b) of one or more commercial establishments that satisfy search criteria, as determined from the request to search. For example, the indications 606 correspond to commercial establishments that satisfy the search criteria for “coffee shops.” In some embodiments, the indications 606 of the commercial establishments are overlaid on the map.

In some embodiments, the mobile application determines whether to filter the search results (e.g., with or without intervention, such as a user request to filter the search results) based on information obtained about the user. For example, the mobile application determines if the user satisfies one or more electric vehicle charging criteria. In some embodiments, the mobile application determines if the user satisfies the one or more EV charging criteria based at least in part on the device from which the request is received (e.g., whether the request is received from a computer integrated into an EV). In some embodiments, the mobile application determines if the user satisfies the one or more EV charging criteria using profile information (e.g., previously stored by the mobile application) of the user, and/or using real-time data collected from the computer system that is executing the mobile application. In some embodiments, the mobile application determines one or more of: if the user owns an EV, if the user is currently located in an EV, if the user's EV has less than a threshold amount of charge, if the request is received from an EV, and/or whether (if received from an EV), the EV from which the request is received has less than a threshold amount of charge.

As such, the mobile application determines whether the user is likely to be interested in charging an EV while at the destination requested by the request to search 602, such that the mobile application provides better results that conveniently allows the user to charge an EV while performing an errand or otherwise spending time at the commercial establishment.

In some embodiments, in accordance with a determination that the user does not satisfy one or more of the EV charging criteria, the mobile application displays the user interface 600 illustrated in FIG. 6A (e.g., showing all of the relevant search results regardless of their proximity to an EVCS).

In some embodiments, in accordance with a determination that the user satisfies one or more of the EV charging criteria, the mobile application automatically filters the search results to include results that match the commercial establishment that are also nearby charging stations, and to exclude results that match the commercial establishment that are not nearby charging stations, as illustrated in FIG. 6B. As used herein, “nearby” or “co-located” means that the charging stations meet predefined criteria with respect to their proximity to the commercial establishment (e.g., that the charging stations are within a certain distance or within the available parking for the commercial establishments).

In some embodiments, the search results are provided to the user after (e.g., an in response to) making the determination of whether the user satisfies one or more of the EV charging criteria (e.g., the mobile application displays the user interface in FIG. 6B without first displaying the user interface in FIG. 6A). For example, the search results are filtered before displaying initial search results. In some embodiments, initial search results are initially displayed (e.g., as illustrated in FIG. 6A) before determining whether the user satisfies one or more of the EV charging criteria, and the user interface is updated to filter the initial search results in accordance with a determination that the user satisfies one or more of the EV charging criteria (e.g., in response to a user request to filter the results).

For example, as illustrated in FIG. 6B, in accordance with a determination that the user satisfies one or more of the EV charging criteria, map 604 only displays indications of commercial establishments that both satisfy the search criteria and are within a predefined proximity of charging stations for electric vehicles. For example, map 604 displays indication 606b but does not display indication 606a (FIG. 6A) in accordance with a determination that the commercial establishment corresponding to indication 606b is near a charging station while the commercial establishment corresponding to indication 606a is not near a charging station.

In some embodiments, the mobile application determines whether the one or more EV charging criteria are met automatically without explicit user input. For example, the user need not request “find a coffee shop nearby with EVCS.” Instead, the user provides a search request for a “coffee shop” and the mobile application (or a server communicatively coupled with the mobile application) automatically determines that the user may also be interested in EV charging stations, and thus filters the results for the user without the user providing additional user input (e.g., without requiring the user to confirm to limit the search results to commercial establishments near an EVCS). For example, the user inputs a search request for “coffee shops nearby” and the mobile application, in accordance with the user satisfying the one or more EV charging criteria, automatically updates the search request to “coffee shops nearby with EVCS” without additional user input. In some embodiments, the mobile application provides a visual indication that the search results are being filtered and allows the user to disable the filtering, and thus return to showing all results.

In some embodiments, in response to the mobile application determining that the user satisfies one or more EV charging criteria, the mobile application prompts the user to confirm that the user would like the search results to be limited to commercial establishments near an EVCS. For example, after the user has requested to search for a “coffee shop,” the mobile application asks the user (e.g., via the user interface, or via an audio output, such as a voice assistant) “would you like to find a coffee shop near an EV charging station?” and waits for the user to select (e.g., confirm) to limit the search results to coffee shops near an EVCS.

In some embodiments, as illustrated in FIG. 6B, in accordance with a determination that the search results include commercial establishments that are co-located with charging stations, an indication of the charging station is provided with the indication of the commercial establishment. For example, as compared to FIG. 6A (e.g., which illustrates search results that include coffee shops nearby without regard to being co-located with EV charging stations), FIG. 6B illustrates that the indications of the commercial establishments include a number of available charging stations co-located with the commercial establishment. For example, indication 606b includes the number “4” to indicate that 4 charging stations are currently available near the coffee shop corresponding to indication 606b.

In some embodiments, the map 604 further filters the search results of the commercial establishments to show only indications of the commercial establishments that satisfy the search criteria and where the charging stations for electric vehicles are available (e.g., currently available, or predicted to be available within a predefined time period). For example, in accordance with a determination that a first commercial establishment is near a charging station, but that the charging station is not available (e.g., under construction or otherwise in use), the search results are filtered and do not show an indication of the first commercial establishment on map 604. In some embodiments, the user is enabled to select (and deselect) whether to show or hide search results that are associated with currently unavailable EV charging stations.

FIG. 6C illustrates user interface 600 that is displayed in response to the user searching for a commercial establishment and requesting navigation in the mobile application. For example, the user requests “Directions to ‘work’” in the mobile application. In response to the user request for directions, a navigation user interface is displayed, including a highlighted navigation route 610 from the user's current location, to the requested destination (e.g., “work”). In some embodiments, the user request for navigation is received before (or after) receiving a user search request. In some embodiments, the user inputs both the request for navigation and the request to search (e.g., for coffee shops) in a same request (e.g., concurrently).

In some embodiments, in accordance with a determination that the mobile application is providing navigation (e.g., directions) to a destination, and in accordance with a determination that the user has requested to search for one or more commercial establishments (e.g., coffee shops), the mobile application, without additional user input, automatically filters the search results for the one or more commercial establishments to only include results that are within a predefined proximity (e.g., in distance or in time, for example 5 miles away or within 5 minutes) of the navigation route 610. For example, the mobile application displays search results that include coffee shops that are located within 5 miles of the highlighted route in FIG. 6C, and excludes the search results for coffee shops that are not located within 5 miles of the highlighted navigation route 610 in FIG. 6C. As such, the mobile application provides the user with options for commercial establishments that match the search criteria and that will be along the user's route with minimal detour.

In some embodiments, the options for commercial establishments that are along the user's route are filtered according to proximity for an EVCS, as described with reference to FIGS. 6A-6B. Thus, a user can ask, “Find a lunch spot along my route,” and the mobile application will show lunch spots that are proximal to EVCSs, allowing the user to charge while getting lunch.

Although the search results described with reference to FIGS. 6A-6C are illustrated on a map, it will be understood that alternative or additional user interfaces may be used to display the search results, such as a list view. Further, the use of a “coffee shop” is just one example of a type of commercial establishment that the user may input as a request to search.

Displaying a representation of commercial establishments co-located with charging stations obviates the need for the user to search for commercial establishments independently of searching for charging stations (e.g., in a separate maps application, such as maps application 549, and a separate EVCS application, such as EVCS mobile application 538). Doing so not only saves time and provides convenience to the user, but also results in a more efficient machine-human interface. Reducing the number of inputs needed by the user to determine where to go and where to charge saves battery power for the user device 112 and reduces the mileage driven by the electric vehicle (e.g., by directing the user to charging stations that happen to be located where the user needs to go anyway). The latter effect reduces wear and tear on electric vehicles and has the general effect of being environmentally friendly by reducing the number of miles driven.

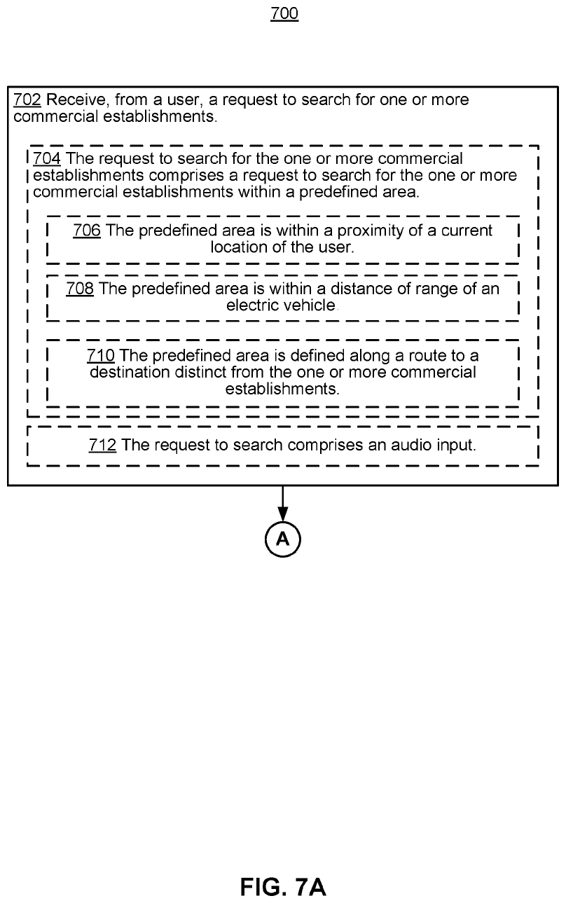

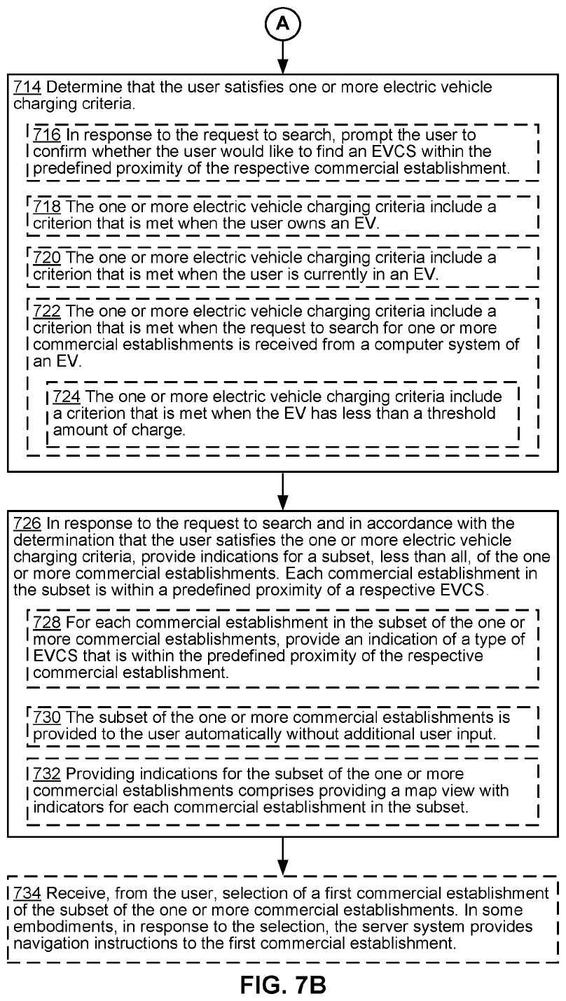

FIGS. 7A-7B illustrate a flowchart of a method 700 of providing in accordance with some implementations. The method 700 is performed at server system with one or more processors, and memory (e.g., server system 120, FIG. 1). The server system receives (702), from a user, a request to search for one or more commercial establishments.

In some embodiments, the request to search for the one or more commercial establishments comprises (704) a request to search for the one or more commercial establishments within a predefined area. For example, the request to search 602 described with reference to FIG. 6A.

In some embodiments, the predefined area is (706) within a proximity of a current location of the user. For example, the user inputs a request to search, “Find a coffee shop nearby” such that the predefined area corresponds to an area within a proximity of a current location of the user (e.g., “nearby”), as described above with reference to FIG. 6A.

In some embodiments, the predefined area is (708) within a distance of range of an electric vehicle. For example, wherein the distance of range corresponds to a maximum range (e.g., on a full charge) of the electric vehicle. In some embodiments, the maximum range is an approximated distance (e.g., calculated by the electric vehicle). In some embodiments, the range of the electric vehicle corresponds to a current range (e.g., based on a current amount of charge). For example, the current range is determined based on communication with the EV, or with a mobile device of the user that accesses battery information of the EV. In some embodiments, the predefined area is selected in accordance with search criteria input by the user in the request to search (e.g., “Find a restaurant within range”).

In some embodiments, the predefined area is (710) defined along a route to a destination distinct from the one or more commercial establishments. For example, in response to a request to search for “a coffee shop on the way to work.” In some embodiments, the predefined area comprises areas along the route within a predefined proximity to the route (e.g., no more than 5 miles off the route), as described with reference to FIG. 6C.

In some embodiments, the request to search comprises (712) an audio input (e g., a voice command). In some embodiments, the request to search is received by a mobile device of the user and/or by a computer system of an electric vehicle (e.g., and the request is forwarded to the server system). In some embodiments, the request includes the geographic location. In some embodiments, the request to search comprises a text input (e.g., typed into the mobile device and/or computer system of the EV). For example, the request to search is entered by the user as text or through speech.

The server system determines (714) (e.g., without user intervention) that the user satisfies one or more electric vehicle charging criteria. In some embodiments, the server system determines whether the user satisfies one or more electric vehicle charging criteria in response to receiving the request to search for the one or more commercial establishments. In some embodiments, determining whether the user satisfies one or more electric vehicle charging criteria comprises requesting information from a mobile device associated with the user and/or a computer system of an electric vehicle associated with the user.

In some embodiments, in response to the request to search, the server system prompts (716) the user to confirm whether the user would like to find an EVCS within the predefined proximity of the respective commercial establishment. In some embodiments, the server system further receives, from the user, a confirmation to search for only commercial establishments that are within a predefined proximity of an EVCS. For example, the server system instructs the mobile device and/or the computer system of the electric vehicle to output a prompt “would you like to search for a coffee shop near an electric vehicle charging station?” and the mobile device and/or computer system is configured to receive an input (e.g., a voice command) from the user in response to the prompt (e.g., “yes”). In some embodiments, after receiving the input from the user, the mobile device and/or the computer system of the EV sends an indication of the user's input to the server system (e.g., whether the user confirmed or rejected the prompt).

In some embodiments, the one or more electric vehicle charging criteria include (718) a criterion that is met when the user owns an EV. For example, the sever system performs a lookup for the user (e.g., in a stored user profile) to determine whether the user is associated with an EV.

In some embodiments, the one or more electric vehicle charging criteria include (720) a criterion that is met when the user is currently in an EV. For example, using location data of the user (e.g., based on location data of a mobile device associated with the user) and/or location data for the EV (e.g., associated with the user), the server system determines a location of the user and the EV. In some embodiments, the EV is communicatively coupled to the server system. In some embodiments, the mobile device of the user is communicatively coupled to the server system and the EV, wherein the mobile device of the user accesses information about the EV (e.g., a current battery level, a location of the EV, etc.).

In some embodiments, the one or more electric vehicle charging criteria include (722) a criterion that is met when the request to search for one or more commercial establishments is received from a computer system of an EV. For example, the server system determines that the request to search is received from the computer system of an EV (e.g., and not from a mobile device of the user, or from a computer system of a non-electric vehicle).

In some embodiments, the one or more electric vehicle charging criteria include (724) a criterion that is met when the EV has less than a threshold amount of charge (e.g., 25%, 50%, 100%). For example, the server system automatically filters the search results to only show “grocery stores” (or another type of commercial establishment in the subset) near EVCSs if the EV has less than 50% charge. In some embodiments, in accordance with a determination that the EV has more than the threshold amount of charge, the server system forgoes filtering the search results (e.g., and provides indications for all of the one or more commercial establishments). In some embodiments, the electric vehicle charging criteria include a criterion that is met when the EV is predicted to have less than a threshold amount of charge when it arrives at the requested location.

In response to the request to search and in accordance with the determination that the user satisfies the one or more electric vehicle charging criteria, the server system provides (726) indications for a subset, less than all, of the one or more commercial establishments (e.g., that satisfy search criteria indicated by the request to search), as described with reference to FIG. 6B. Each commercial establishment in the subset is within a predefined proximity of a respective electric vehicle charging station (EVCS). In some embodiments, the server system provides indications for the subset without providing indications for the one or more commercial establishments that are not within the predefined proximity of a respective EVCS (e.g., that are not in the subset). In some embodiments, providing the indications comprises a search result (e.g., in a list view and/or in a map view).

In some embodiments, for each commercial establishment in the subset of the one or more commercial establishments, the server system provides (728) an indication of a type of EVCS that is within the predefined proximity of the respective commercial establishment. For example, the indication includes an indicator of whether the charging station is level 1, level 2, DC fast chargers, etc. and/or an identifier of a provider (e.g., brand) of the charging station. In some embodiments, the method further comprises providing an indication of availability of the EVCS (e.g., a number of available EVCSs at each commercial establishment, as described with reference to FIG. 6B).

In some embodiments, the subset of the one or more commercial establishments is (730) provided to the user automatically without additional user input. For example, the server system provides the search results by automatically filtering the one or more commercial establishments to the subset of the one or more commercial establishments that are within the predefined proximity of an EVCS (e.g., without prompting the user to confirm and/or without the user providing additional input requesting to find an EVCS nearby). For example, the user need not specify to search for “a coffee shop near an EVCS,” wherein a request to search for “a coffee shop” causes the server system to provide only the subset of commercial establishments near an EVCS (without the user explicitly requesting to filter the results based on proximity to an EVCS).

In some embodiments, providing indications for the subset of the one or more commercial establishments comprises (732) providing a map view with indicators for each commercial establishment in the subset. For example, the server system instructs the mobile device and/or the computer system of the EV to display a map view with the search results.

In some embodiments, the server system receives (734), from the user, selection of a first commercial establishment of the subset of the one or more commercial establishments. In some embodiments, in response to the selection, the server system provides navigation instructions to the first commercial establishment, as described above with reference to FIG. 6C.

Allowing users to filter a map of available electric vehicle charging stations by retail outlet or category of retail outlet promotes efficient routing of excursions, saves battery power and reduces wear and tear on electric vehicles.

It will be understood that, although the terms first, second, etc., are, in some instances, used herein to describe various elements, these elements should not be limited by these terms. These terms are only used to distinguish one element from another. For example, a first widget could be termed a second widget, and, similarly, a second widget could be termed a first widget, without departing from the scope of the various described implementations. The first widget and the second widget are both widget, but they are not the same condition unless explicitly stated as such.

The terminology used in the description of the various described implementations herein is for the purpose of describing particular implementations only and is not intended to be limiting. As used in the description of the various described implementations and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising.” when used in this specification, specify the presence of stated features, integers, steps, operations, elements, and/or components, but do not preclude the presence or addition of one or more other features, integers, steps, operations, elements, components, and/or groups thereof.

The foregoing description, for purpose of explanation, has been described with reference to specific implementations. However, the illustrative discussions above are not intended to be exhaustive or to limit the scope of the claims to the precise forms disclosed. Many modifications and variations are possible in view of the above teachings. The implementations were chosen in order to best explain the principles underlying the claims and their practical applications, to thereby enable others skilled in the art to best use the implementations with various modifications as are suited to the particular uses contemplated.

1. A method, comprising:
at a server system with one or more processors and memory:
receiving, from a user, a request to search for one or more commercial establishments;
determining that the user satisfies one or more electric vehicle charging criteria; and
in response to the request to search and in accordance with the determination that the user satisfies the one or more electric vehicle charging criteria, providing indications for a subset, less than all, of the one or more commercial establishments, wherein each commercial establishment in the subset is within a predefined proximity of a respective electric vehicle charging station (EVCS).

2. The method of claim 1, further comprising:
receiving, from the user, selection of a first commercial establishment of the subset of the one or more commercial establishments; and
in response to the selection, providing navigation instructions to the first commercial establishment.

3. The method of claim 1, further comprising, for each commercial establishment in the subset of the one or more commercial establishments, providing an indication of a type of EVCS that is within the predefined proximity of the respective commercial establishment.

4. The method of claim 1, wherein the request to search for the one or more commercial establishments comprises a request to search for the one or more commercial establishments within a predefined area.

5. The method of claim 4, wherein the predefined area is within a proximity of a current location of the user.

6. The method of claim 4, wherein the predefined area is within a distance of range of an electric vehicle.

7. The method of claim 4, wherein the predefined area is defined along a route to a destination distinct from the one or more commercial establishments.

8. The method of claim 1, wherein the request to search comprises an audio input.

9. The method of claim 1, further comprising: in response to the request to search, prompting the user to confirm whether the user would like to find an EVCS within the predefined proximity of the respective commercial establishment.

10. The method of claim 1, wherein the subset of the one or more commercial establishments is provided to the user automatically without additional user input.

11. The method of claim 1, wherein the one or more electric vehicle charging criteria include a criterion that is met when the user owns an EV.

12. The method of claim 1, wherein the one or more electric vehicle charging criteria include a criterion that is met when the user is currently in an EV.

13. The method of claim 1, wherein the one or more electric vehicle charging criteria include a criterion that is met when the request to search for one or more commercial establishments is received from a computer system of an EV.

14. The method of claim 13, wherein the one or more electric vehicle charging criteria include a criterion that is met when the EV has less than a threshold amount of charge.

15. The method of claim 1, wherein providing indications for the subset of the one or more commercial establishments comprises providing a map view with indicators for each commercial establishment in the subset.

16. A computer system comprising one or more processors and memory storing one or more programs for execution by the one or more processors, the one or more programs including instructions for performing a set of operations, comprising:
receiving, from a user, a request to search for one or more commercial establishments;
determining that the user satisfies one or more electric vehicle charging criteria; and
in response to the request to search and in accordance with the determination that the user satisfies the one or more electric vehicle charging criteria, providing indications for a subset, less than all, of the one or more commercial establishments, wherein each commercial establishment in the subset is within a predefined proximity of a respective electric vehicle charging station (EVCS).

17. A computer-readable storage medium comprising one or more programs, the one or more programs including instructions, which, when executed by a computer system with one or more processors, cause the computer system to perform a set of operations, comprising:
receiving, from a user, a request to search for one or more commercial establishments;
determining that the user satisfies one or more electric vehicle charging criteria; and
in response to the request to search and in accordance with the determination that the user satisfies the one or more electric vehicle charging criteria, providing indications for a subset, less than all, of the one or more commercial establishments, wherein each commercial establishment in the subset is within a predefined proximity of a respective electric vehicle charging station (EVCS).
